(19) United States
(12) Patent Application Publication
(10) Pub. No.: US 2026/0048386 A1
(43) Pub. Date: Feb. 19, 2026

(54) METHOD OF SYNTHESIZING NANO ZEOLITE

(71) Applicant: KING FAHD UNIVERSITY OF PETROLEUM AND MINERALS, Dhahran (SA)

(72) Inventors: Mohammed Ahmed SANHOOB, Dhahran (SA); Galal Atef NASSER, Dhahran (SA); Akolade Idris BAKARE, Dhahran (SA); Oki Muraza MULUK, Dhahran (SA); Mohammed Nasiruzzaman SHAIKH, Dhahran (SA)

(73) Assignee: KING FAHD UNIVERSITY OF PETROLEUM AND MINERALS, Dhahran (SA)

(21) Appl. No.: 18/884,482

(22) Filed: Sep. 13, 2024

(30) Foreign Application Priority Data
Aug. 18, 2024 (SA) 1020244559

(51) Int. Cl. B01J 29/40; B01J 35/40; B01J 35/51; B01J 35/61; B01J 35/63; B01J 37/00; B01J 37/03; B01J 37/08; C01B 39/40; C10G 11/05

(52) U.S. Cl. CPC B01J 29/40; B01J 35/40; B01J 35/51; B01J 35/615; B01J 35/633; B01J 35/635; B01J 37/0018; B01J 37/031; B01J 37/08; C01B 39/40; C10G 11/05; B01J 2229/37; C01P 2002/60; C01P 2002/72; C01P 2004/03; C01P 2004/32; C01P 2006/12; C01P 2006/14; C10G 2300/1081; C10G 2300/1096; C10G 2400/20; C10G 2400/30

(57) ABSTRACT

A method of making ZSM-5 includes mixing an aluminum salt and a templating agent in water to form a first mixture, mixing a silicate with the first mixture, and heating from 100° C. to 150° C. to form a second mixture. The method further includes separating the first precipitate from the second mixture and calcining the first precipitate at a temperature of 400° C. to 600° C. for 1 to 12 hours to form a first zeolite. Further, the method includes mixing an ammonium salt and the first zeolite to form a protonated zeolite and calcining the protonated zeolite at a temperature of 400° C. to 600° C. for 1 to 12 hours to form the ZSM-5. The ZSM-5 has a silicon (Si) to aluminium (Al) ratio of 10-100 to 1, and a mesoporous pore volume of the ZSM-5 is at least 2 times greater than a microporous pore volume of the ZSM-5.

### CROSS-REFERENCE TO RELATED APPLICATIONS

The present disclosure claims the benefit of Saudi Patent Application No. 1020244559, filed on Aug. 18, 2024, with the Saudi Authority for Intellectual Property Office, which is incorporated herein by reference in its entirety.

### BACKGROUND

### Technical Field

The present disclosure is directed towards nanozeolitic structures, and more particularly, directed towards a method of synthesizing nano zeolite Socony mobil-5 (ZSM-5) with controlled textural and acidic properties.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

With the advent of technology, the oil industry has reached high levels technically, ergonomically, cognitively, industrially, and evolutionarily. However, a great challenge with the oil industry is huge oil and petroleum consumption worldwide, which has made petrochemical companies and researchers strive for advances in global economics. In addition, the continuous draining of petroleum products may prevent the full exploitation of oil and industrial developments if not overcome with heterogeneous catalysts, especially zeolitic materials, considered the cornerstone catalysts of converting heavy oil and naphtha into valuable products for society. Further, the optimal utilization of heavy oil is highly dependent on the effectiveness of zeolitic materials and their ability to transform heavy naphtha into more valuable chemicals. The conversion rate of heavy oil into valuable compounds is highly dependent on the physical properties and synthesis methods of zeolitic materials. Modifying and tuning the features of the physical properties of the zeolitic materials is vital for the selectivity of the catalytic reaction, zeolitic activity, and stability; hence, the modified zeolite may provide benefits to heavy oil produced from the reservoir products with minimum cost.

Over 200 zeolitic materials are available with different topologies and frameworks (See: Baerlocher, C., L. B. McCusker, and D. H. Olson, Atlas of zeolite framework types, Atlas of Zeolite Framework Types. 2007: Elsevier Science). However, these zeolites need to be modified to be useful for catalytic reaction of heavy oil. Nevertheless, many one-dimensional and three-dimensional (3D) zeolites, such as BEA, FAU, and MFI zeolites, may be used for the catalytic cracking of heavy naphtha. However, the common factor in all these zeolitic materials is surface acidity and textural properties. A crucial 3D zeolite currently available is ZSM-5 zeolite with MFI topology. The first synthesis of ZSM-5 (MFI) was firstly synthesized by Mobil research and development scientists (See: Argauer, R. J. and G. R. Landolt, Crystalline zeolite ZSM-5 and method of preparing the same, Crystalline zeolite zsm-5 and method of preparing the same. 1972, U.S. Pat. No. 3,702,886A). ZSM-5 became the most famous zeolite industrially due to its activity in many catalytic reactions such as catalytic cracking, isomerization, hydrogenation, and aromatization (See: Borade, R. B., et al., Active centers over hzsm5 zeolites for paraffin cracking, Bizreh, Y. W., and B. C. Gates, Butane cracking catalyzed by the zeolite H-ZSM-5, Kanai, J., Aromatization of N-Hexane Over Ga—H-Zsm-5 Catalysts, and Lugstein, A., A. Jentys, and H. Vinek, Hydroisomerization and cracking of n-octane and C8 isomers on Ni-containing zeolites, Applied Catalysis, 1984. 13(1): p. 27-38).

Crystalline ZSM-5 was first synthesized by a conventional method using tetraalkylammonium cations such as tetrapropylammonium cationic source as an organic structure directing agent by U.S. Pat. No. 3,702,886. After that, it was possible to synthesize ZSM-5 zeolite by involving two organic cations, tetrapropylammonium (TPA) and tetramethylammonium (TMA) cations, to synthesize large crystal size by U.S. Pat. No. 5,182,090. However, the latest technological research depends on nanotechnology, which strives to reduce the diffusional length and reduce mass transfer limitation. This may be achieved by synthesizing small crystal sizes with the same zeolitic structure. This also helps in increasing the external surface area of the zeolite. Several prior arts disclosed the procedure of synthesizing small crystal ZSM-5 zeolite with different formulation methods. The synthesis of small crystal ZSM-5 was disclosed in U.S. Pat. Nos. 5,240,892, 6,504,075, U.S. 20150298981, EP 3056470, and others.

Several researchers studied the isomorphic incorporations of different kinds of trivalent and/or tetravalent heteroatoms such as aluminum, iron, titanium, zirconium, germanium, gallium, and boron, for instance, U.S. Pat. No. 3,790,471; EP0756891; JP2010536692; U.S. Pat. Nos. 3,329,481; 3,329,480; EP0337835; U.S. Pat. Nos. 4,180,689 and 3,328,119. It was found that when aluminum is used, the acidity content is proportional to the aluminum content in the framework, and the acidity presence can be attributed to both Lewis and Brønsted acid sites.

Although many studies were carried out on MFI zeolite using different heating methods and different kinds of chemical sources, these methods result in decreased Brønsted acidity and loss of silanol groups, thereby impacting the scope for manipulating the acidity and reactivity of zeolite. Accordingly, an object of the present disclosure is to provide a method of making ZSM-5 using sequence methods to control, adjust, and restore the catalytic Lewis and Brønsted acidity levels and textural properties.

### SUMMARY

In an exemplary embodiment, a method of making zeolite Socony Mobil—5 (ZSM-5) is described. The method includes mixing an aluminum salt and a templating agent in water to form a first mixture, mixing a silicate with the first mixture, and heating from 100 degrees Celsius (° C.) to 150° C. to form a second mixture. The method further includes separating a first precipitate from the second mixture, calcining the first precipitate at a temperature of 400° C. to 600° C. for 1 to 12 hours to form a first zeolite. The method further includes mixing an ammonium salt and the first zeolite to form a protonated zeolite, and calcining the protonated zeolite at a temperature of 400° C. to 600° C. for 1 to 12 hours to form the ZSM-5. The ZSM-5 has a silicon (Si) to aluminium (Al) ratio of 10-100 to 1, and a mesoporous pore volume of the ZSM-5 is at least 2 times greater than a microporous pore volume of the ZSM-5.

In some embodiments, the ZSM-5 is crystalline.

In some embodiments, particles of the ZSM-5 are spherical.

In some embodiments, particles of the ZSM-5 have an average size of 200 nanometers (nm) to 400 nm.

In some embodiments, the ZSM-5 has a Brunauer-Emmett-Teller (BET) surface area of 350 square meters per gram (m²/g) to 450 m²/g.

In some embodiments, the ZSM-5 has a micropore surface area of 180 m²/g to 220 m²/g.

In some embodiments, the ZSM-5 has an external surface area of 150 m²/g 220 m²/g.

In some embodiments, the ZSM-5 has a total pore volume of 0.40 cubic centimeters per gram (cm³/g) to 0.50 cm³/g.

In some embodiments, the ZSM-5 has a mesoporous pore volume of 0.32 cm³/g to 0.39 cm³/g.

In some embodiments, the ZSM-5 has a microporous pore volume of 0.08 cm³/g to 0.11 cm³/g.

In some embodiments, the mesoporous pore volume at least 3 times greater than the microporous pore volume of the ZSM-5.

In some embodiments, the ZSM-5 has a Lewis acid scale in the range of 20 micromoles per gram (mol/g) to 50 mol/g.

In some embodiments, the ZSM-5 has a Brønsted acid scale in the range of 20 mol/g to 55 mol/g.

In some embodiments, the ZSM-5 does not include the templating agent, an alkali metal, or an alkaline earth metal.

In some embodiments, a ZSM-5 made by the method of the present disclosure.

In another exemplary embodiment, a method of cracking dodecane or heavy naphtha is described. The method includes contacting the dodecane with the ZSM-5 to form a conversion product, the conversion product is at least one selected from the group consisting of olefins, and aromatic compounds.

In some embodiments, the conversion product is 30 percent by volume (vol. %) to 40 vol. % of the aromatic compounds.

In some embodiments, a yield of catalytic cracking of the dodecane is from 90% to 95% and a yield of catalytic cracking of the heavy naphtha is from 40% to 70%.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart illustrating a method for making zeolite Socony mobil—5 (ZSM-5), according to certain embodiments.

FIG. 1B a schematic block diagram of a process scheme for synthesis of ZSM-5, according to certain embodiments.

FIG. 2 shows an X-ray diffraction (XRD) analysis of the ZSM-5 synthesized with different silicon/aluminum (Si/Al) ratios, according to certain embodiments.

FIG. 3 shows XRD analysis of the ZSM-5 synthesized with a Si/Al ratio of 50, prior to and after calcination, according to certain embodiments.

FIG. 4 shows XRD analysis of the ZSM-5 synthesized with a Si/Al ratio of 50 with different calcination time periods, prior to and after protonation, according to certain embodiments.

FIG. 5 shows field emission scanning electron microscopy (FESEM) micrographs of ZSM-5 with a Si/Al ratio of 100, ZSM-5 with Si/Al ratio of 75, and ZSM-5 with Si/Al ratio of 50, according to certain embodiments.

FIG. 6 is a graph showing the isotherm profile of the ZSM-5 synthesized with a Si/Al ratio of 50, according to certain embodiments.

FIG. 7 shows an ammonia temperature programmed desorption (NH3-TPD) profile measuring the acidity of the ZSM-5 synthesized with a Si/Al ratio of 50, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “zeolitic material” refers to a material having a crystalline structure or three-dimensional framework of, but not necessarily the elemental composition of, a zeolite. Zeolites are porous silicate or aluminosilicate minerals that occur in nature. Elementary building units of zeolites are SiO₄ (and if appropriate, AlO₄) tetrahedra. Adjacent tetrahedra are linked at their corners via a common oxygen atom, which results in an inorganic macromolecule with a three-dimensional framework (frequently referred to as the zeolite framework). The three-dimensional framework of a zeolite also includes channels, channel intersections, and/or cages having dimensions in the range of 0.1-10 nanometers (nm), preferably 0.2-5 nm, more preferably 0.2-2 nm. Water molecules may be present inside these channels, channel intersections, and/or cages. Zeolites which are devoid of aluminum may be referred to as “all-silica zeolites” or “aluminum-free zeolites”. Some zeolites which are substantially free of, but not devoid of, aluminum is referred to as “high-silica zeolites”. Sometimes, the term “zeolite” is used to refer exclusively to aluminosilicate materials, excluding aluminum-free zeolites or all-silica zeolites.

In some embodiments, the zeolitic material has a three-dimensional framework that is at least one zeolite framework selected from the group consisting of a 4-membered ring zeolite framework, a 6-membered ring zeolite framework, a 10-membered ring zeolite framework, and a 12-membered ring zeolite framework. The zeolite may have a natrolite framework (e.g., gonnardite, natrolite, mesolite, paranatrolite, scolecite, and tetranatrolite), edingtonite framework (e.g. edingtonite and kalborsite), thomsonite framework, analcime framework (e.g. analcime, leucite, pollucite, and wairakite), phillipsite framework (e.g. harmotome), gismondine framework (e.g. amicite, gismondine, garronite, and gobbinsite), chabazite framework (e.g. chabazite-series, herschelite, willhendersonite, and SSZ-13), faujasite framework (e.g. faujasite-series, Linde type X, and Linde type Y), mordenite framework (e.g. maricopaite and mordenite), heulandite framework (e.g. clinoptilolite and heulandite-series), stilbite framework (e.g. barrerite, stellerite, and stilbite-series), brewsterite framework, or cowlesite framework. In some embodiments, the porous silicate and/or aluminosilicate matrix is a zeolitic material having a zeolite framework selected from the group consisting of ZSM-5, ZSM-8, ZSM-11, ZSM-12, ZSM-18, ZSM-23, ZSM-35, and ZSM-39.

As used herein, the term ‘templating agent’ refers to the molecule or ion that directs or templates the formation of a specific structure during the synthesis of materials such as zeolites, metal-organic frameworks (MOFs), and other porous materials. Templating agents can be organic molecules, inorganic ions, or even solvent molecules that interact with the precursor materials in a way that influences the final crystalline structure and porosity of the synthesized material.

As used herein, the term ‘olefins’, also known as alkenes, are unsaturated hydrocarbons containing at least one carbon-carbon double bond in their molecular structure. The general formula for olefins is CₙH₂ₙ, where ‘n’ is the number of carbon atoms. Due to their double bond, olefins can undergo addition reactions, where atoms or groups of atoms are added to the carbon-carbon double bond. Ethylene (C₂H₄) and propylene (C₃H₆) are common examples of olefins. Olefins are widely used in plastics, detergents, synthetic rubber, and other industrial chemicals.

The term ‘aromatic compounds’ or ‘aromatic rings’, as used herein, refers to hydrocarbon rings that, by the theory of Hickel, have a cyclic, delocalized (4n+2) pi-electron system. Non-limiting examples of aromatic compounds include benzene, benzene derivatives, compounds having at least one benzene ring in their chemical structure, toluene, ethylbenzene, p-xylene, m-xylene, mesitylene, durene, 2-phenylhexane, biphenyl, phenol, aniline, nitrobenzene, and the like.

Aspects of the present disclosure are directed to a process of preparing ZSM-5 zeolites with different Si/Al ratios using sequence methods to control, adjust, and restore the catalytic Lewis and Brønsted acidity levels. The as-prepared ZSM-5 was evaluated for its catalytic activity during the catalytic cracking of hydrocarbons, particularly dodecane. The results indicate that the ZSM-5 zeolite shows high catalytic stability and selectivity.

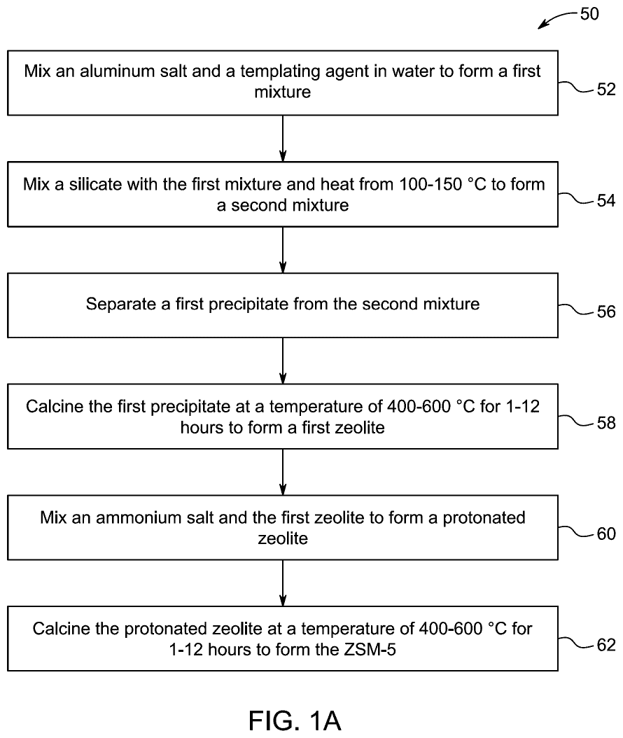

FIG. 1A illustrates a schematic flow chart of a method 50 of making ZSM-5, also referred to as the nanosized MFI or zeolite formulation. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing an aluminum salt and a templating agent in water to form a first mixture. The aluminum salt may include, but is not limited to, aluminum chloride, aluminum sulfate, aluminum hydroxide, aluminum isopropoxide, aluminum nitrate (Al(NO₃)₃), aluminum acetate, and/or mixtures thereof. In a preferred embodiment, the aluminum salt is aluminum sulfate, preferably its hydrate thereof, and more preferably aluminum sulfate octahydrate (Al₂(SO₄)₃.18H₂O). Typically, the aluminum salt is dissolved in water; optionally, other solvents, such as alcohols, may be present as well to form a solution. The dissolution is carried out until the aluminum salt is completely dissolved in water; and is performed prior to mixing the aluminum salt with the templating agent. The dissolution may be facilitated using mixing/stirring/agitation, and the like. The w/w ratio of the aluminum salt to water may vary depending on the desired Si/Al ratio. In a preferred embodiment, the water may be tap water, distilled water, bi-distilled water, deionized water, deionized distilled water, reverse osmosis water, and/or some other water. In a preferred embodiment, the water is deionized water. As used herein, the term ‘deionized water’ refers to water that has had (most of) the ions removed. In a preferred embodiment, the w/w ratio of water to aluminum salt is in the range of 50:1 to 250:1. To the solution, is added the templating agent or organic structure directing agent (OSDA). The templating agent plays a critical role in influencing the crystalline size, morphology, pore size, and pore volume of the zeolite. Suitable examples of the templating agent are surfactants, which may include, but is not limited to, cetyltrimethylammonium bromide (CTAB), tetraethylammonium hydroxide (TEAOH), triethylamine (TEA), tetramethylammonium hydroxide (TMAOH), hexadecylamine (HDA), polyethylene glycol (PEG), tetrapropylammonium hydroxide (TPAOH) and mixtures thereof. In a preferred embodiment, the templating agent is TPAOH. The molar concentration of the templating agent is in the range of 0.5-5 M, preferably 1-3 M, preferably 1 M. In some embodiments, seed crystals of ZSM-5 may be combined with the templating agent to facilitate the zeolite formation.

At step 54, the method 50 includes mixing a silicate with the first mixture and heating from 100-150° C., more preferably 105-115° C., and yet more preferably 110° C. to form a second mixture. The silicate is added to the first mixture to form a zeolite solution. The weight ratio of the silicate to the aluminum salt in the first mixture is in the range of 15:1 to 62:1. The silicate may be in the form of amorphous silica, fumed silica, colloidal silica, tetraethyl orthosilicate (TEOS), sodium silicate, potassium silicate, lithium silicate, or the like can be used. In some embodiments, the silicate is an orthosilicate, preferably TEOS. It is preferred that the silicate is hydrolyzed—via vigorous stirring/agitation for 60-120 minutes, preferably for about 90 minutes, or by any other known methods before heating. In some embodiments, various alkaline solutions may be adopted to hydrolyze TEOS. In one embodiment, the alkaline solution may comprise NaOH. In specific embodiments, the alkaline solution may comprise 0.01 to 0.2 Molarity (M) NaOH, 0.05 to 0.2 Molarity (M) NaOH, or 0.05 to 0.1 M NaOH. In a preferred embodiment, the hydrolysis is performed without using the alkaline solution. In some embodiments, the zeolite solution may be aged 30 minutes to 3 days to enhance the hydrolysis of TEOS and the nucleation rate.

Various heating processes or elements are contemplated. For example, the heating may be hydrothermal heating. The hydrothermal heating is typically carried out in a sealed Teflon-lined, stainless-steel autoclave (at temperatures typically below 250° C., preferably between 50-250° C.), preferably at 100-150° C., more preferably 105-115° C., and yet more preferably 110° C. Furthermore, the duration of hydrothermal heating may range from 13 hours to 17 hours, preferably 15 hours, to yield a second mixture. The second mixture includes a first precipitate formed by the reaction between the aluminum salt and the hydrolyzed silicate, as well as some unreacted portion.

At step 56, the method 50 includes separating a first precipitate from the second mixture. The second mixture may also include unreacted reactants and solvents, which are separated from the first mixture. In some embodiments, separation of the first precipitate from the second mixture can be done by filtration, centrifugation, decantation, dissolution and recrystallization, selective precipitation, and/or combination thereof. In a preferred embodiment, the second mixture is centrifuged at around 2500-3000 rotations per minute (rpm) to obtain the first precipitate. The first precipitate was further dried at a temperature range of 90° C. to 110° C., preferably 100° C., for drying time between 10 hours to 20 hours to remove water.

At step 58, the method 50 includes calcining the first precipitate at a temperature of 400-600° C. for 1-12 hours to form a first zeolite. As used herein, the term ‘calcination’ refers to the thermal treatment process that involves heating a substance, typically a solid material, to a high temperature in the absence or limited presence of air or oxygen. The calcination process may involve one or more steps. Typically, the calcination may be performed by any conventional method or apparatus known to a person skilled in the art, for example, but not limited to, using a muffle furnace, electric furnace, tube furnace, box furnace, crucible furnace, microwave furnace, vacuum furnace, rotary kiln, or fluidized bed furnace. The calcination process aims to remove the templating agent from the first zeolite. In some embodiments, other methods can be performed to remove the templating agent from the pores of the first zeolite instead of calcination.

In an embodiment, the calcination was carried out by heating the first precipitate to a temperature range of 400° C. to 600° C., preferably 450° C. to 570° C., preferably at about 530° C. to 570° C., and preferably 550° C., at a heating rate of 1-20° C./min, preferably 1-15° C./min, preferably 1-10° C./min, preferably 1-5° C./min, and more preferably at about 1-3° C./min in an inert nitrogen/argon/synthetic air/atmosphere, in a controlled manner. This process was carried out for about 2-12 hours to form the first zeolite.

In a specific embodiment, the first precipitate is calcined for 1.5 hours to form the first zeolite. In another embodiment, the first precipitate is calcined for 5 hours to form the first zeolite. In yet another embodiment, the first precipitate is calcined for 12 hours to form the first zeolite. In some embodiments, the first zeolite obtained after calcining the first precipitate for 1.5 hours has a Lewis acid scale of 76±15 mole/g. In some embodiments, the first zeolite obtained after calcining the first precipitate for 5 hours has a Lewis acid scale of 52±15 mole/g. In some embodiments, the first zeolite obtained after calcining the first precipitate for 12 hours has a Lewis acid scale of 24±15 mole/g. It can be observed that calcination time affects the acidic character of the first zeolite. Increasing the calcination time resulted in reduced acidic sites. It is desirable to have a zeolite with improved acid sites for better catalytic stability and applicability. Hence, the steps described below further modify/tune/control the surface properties of the first zeolite, such as surface area, pore volume, surface acidity, and textural properties.

At step 60, the method 50 includes mixing an ammonium salt and the first zeolite to form a protonated zeolite. The ammonium salt may include, but is not limited to, ammonium chloride, ammonium nitrate, ammonium sulfate, ammonium phosphate, ammonium carbonate. In a preferred embodiment, the ammonium salt is ammonium nitrate. The molar concentration of the ammonium salt, particularly ammonium nitrate, is in the range of 0.01 M to 5 M, preferably 0.05 M to 4 M, preferably 0.1 M to 2 M. The weight ratio of the ammonium salt to the first zeolite is in the range of 1:10 to 1:20. In a specific embodiment, the weight ratio of the ammonium salt to the first zeolite is 1:10. In another specific embodiment, the weight ratio of the ammonium salt to the first zeolite is 1:20. In some embodiments, a mixture of the first zeolite and the ammonium salt is heated to a temperature of 85±3° C. for 1-6, preferably 3-4 hours, in an oven (or any other heating appliance known in the art) to obtain the a solution containing the protonated zeolite and unreacted ammonium nitrate. As used herein, protonated zeolite refers to the zeolite material that has been modified or treated to replace some or all its original cations (typically sodium or potassium ions) with protons (H⁺ ions). This process involves ion exchange, where the original cations in the zeolite framework are replaced by protons from an acidic solution. The unreacted ammonium nitrate may be removed by washing the protonated zeolite with water, preferably de-ionized water. In an embodiment, the protonated zeolite may be mixed with ammonium nitrate multiple times, preferably 1-3 times, to increase its acidic character. The protonated zeolite was further dried at a temperature range of 90° C. to 110° C., preferably 100° C., for drying time between 10 hours to 20 hours to remove water.

At step 62, the method 50 includes calcining the protonated zeolite at a temperature of 400-600° C. for 1-12 hours to form the ZSM-5. The protonated zeolite is further calcined to 400° C. to 600° C., preferably 450° C. to 570° C., preferably at about 530° C. to 570° C., and preferably 550° C., at a heating rate of 1-20° C./min, preferably 1-15° C./min, preferably 1-10° C./min, preferably 1-5° C./min, more preferably at about 1-3° C./min in an inert nitrogen/argon/synthetic air/atmosphere, in a controlled manner. This process was carried out for about 2-12 hours, preferably 1.5 to 5 hours, to form the ZSM-5. The ZSM-5 obtained does not include the templating agent, an alkali metal, or an alkaline earth metal.

The ZSM-5 has a Si to Al ratio of 10-100 to 1, preferably 25:1 to 100:1, including 25:1, 50:1, 75:1, and 100:1. In a preferred embodiment, the ZSM-5 has a Si to Al ratio of 50:1. The ZSM-5 is crystalline. The merits of crystalline ZSM-5 are uniform pore structure, high surface area, thermal and chemical stability, catalytic activity, versatility, and synthetic control. Particles of the ZSM-5 are spherical and have an average size of 200-400 nm, more preferably 240-300 nm. In an embodiment, particles of the ZSM-5 with a Si/Al ratio of 75:1 have an average particle size of about 260 nm. In another embodiment, particles of the ZSM-5 with a Si/Al ratio of 100:1 have an average particle size of about 257 nm. In yet another embodiment, particles of the ZSM-5 with a Si/Al ratio of 50:1 have an average particle size of about 283 nm.

The ZSM-5 has a BET surface area of 350-450 m²/g. In an embodiment, the ZSM-5 with a Si/Al ratio of 100:1 has a BET surface area of 405.2 m²/g. In another embodiment, the ZSM-5 with a Si/Al ratio of 75:1 has a BET surface area of 405.4 m²/g. In yet another embodiment, the ZSM-5 with a Si/Al ratio of 50:1 has a BET surface area of 418 m²/g. In yet another embodiment, the ZSM-5 has a BET surface area of 406.1 m²/g. In yet another embodiment, the ZSM-5 has a BET surface area of 351.3 m²/g.

The ZSM-5 has a micropore surface area of 180-220 m²/g. In an embodiment, the ZSM-5 with a Si/Al ratio of 100:1 has a micropore surface area of 199 m²/g. In another embodiment, the ZSM-5 with a Si/Al ratio of 75:1 has a micropore surface area of 205 m²/g. In another embodiment, the ZSM-5 with a Si/Al ratio of 50:1 has a micropore surface area of 202 m²/g. In yet another embodiment, the ZSM-5 with a Si/Al ratio of 50:1 has a micropore surface area of 209 m²/g. In another embodiment, the ZSM-5 with a Si/Al ratio of 50:1 has a micropore surface area of 185 m²/g.

The ZSM-5 has an external surface area of 150-220 m²/g. In an embodiment, the ZSM-5 with a Si/Al ratio of 100:1 has an external surface area of 199 m²/g. In another embodiment, the ZSM-5 with a Si/Al ratio of 75:1 has an external surface area of 198 m²/g. In yet another embodiment, the ZSM-5 with a Si/Al ratio of 50:1 has an external surface area of 216 m²/g. In yet another embodiment, the ZSM-5 with a Si/Al ratio of 50:1 has an external surface area of 197 m²/g. In yet another embodiment, the ZSM-5 with a Si/Al ratio of 50:1 has an external surface area of 166 m²/g.

The mesoporous pore volume of the ZSM-5 is at least 2 times, preferably 3 times, and yet more preferably about 3.5 times, greater than a microporous pore volume of the ZSM-5. The ZSM-5 has a mesoporous pore volume of 0.32-0.39 cm³/g. In an embodiment, the ZSM-5 with a Si/Al ratio of 100:1 has a mesoporous pore volume of 0.358 cm³/g. In another embodiment, the ZSM-5 with a Si/Al ratio of 75:1 has a mesoporous pore volume of 0.337 cm³/g. In another embodiment, the ZSM-5 with a Si/Al ratio of 50:1 has a mesoporous pore volume of 0.331 cm³/g. In another embodiment, the ZSM-5 with a Si/Al ratio of 50:1 has a mesoporous pore volume of 0.324 cm³/g. In another embodiment, the ZSM-5 with a Si/Al ratio of 50:1 has a mesoporous pore volume of 0.387 cm³/g.

The ZSM-5 has a microporous pore volume of 0.08-0.11 cm³/g. In an embodiment, the ZSM-5 with a Si/Al ratio of 100:1 has a microporous pore volume of 0.101 cm³/g. In another embodiment, the ZSM-5 with a Si/Al ratio of 75:1 has a microporous pore volume of 0.102 cm³/g. In another embodiment, the ZSM-5 with a Si/Al ratio of 50:1 has a microporous pore volume of 0.097 cm³/g. In another embodiment, the ZSM-5 with a Si/Al ratio of 50:1 has a microporous pore volume of 0.103 cm³/g. In another embodiment, the ZSM-5 with a Si/Al ratio of 50:1 has a microporous pore volume of 0.088 cm³/g.

The ZSM-5 has a total pore volume of 0.40-0.50 cm³/g. In an embodiment, the ZSM-5 with a Si/Al ratio of 100:1 has a total pore volume of 0.459 cm³/g. In another embodiment, the ZSM-5 with a Si/Al ratio of 75:1 has a total pore volume of 0.439 cm³/g. In yet another embodiment, the ZSM-5 with a Si/Al ratio of 50:1 has a total pore volume of 0.428 cm³/g. In another embodiment, the ZSM-5 with a Si/Al ratio of 50:1 has a total pore volume of 0.427 cm³/g. In another embodiment, the ZSM-5 with a Si/Al ratio of 50:1 has a total pore volume of 0.475 cm³/g.

The ZSM-5 has a Lewis acid scale in the range of 20-50 μmol/g. The Lewis acid scale refers to the quantitative measure of the strength of Lewis acids based on their ability to accept electron pairs. Lewis's acids are chemical species that can accept a pair of electrons to form a new covalent bond. The strength of a Lewis acid can vary significantly depending on its chemical structure and electronic properties. The ZSM-5 has a Brønsted acid scale in the range of 20-55 μmol/g. The Brønsted acid scale, also known as the Brønsted-Lowry acid-base theory, defines acids and bases based on proton transfer in chemical reactions.

The ZSM-5 of the present disclosure can be used for catalytic cracking of dodecane or heavy naphtha. The method includes contacting the dodecane with the ZSM-5 to form a conversion product. The method may include contacting the dodecane with the ZSM-5 in a reactor. The reactor is at least one of a fixed-bed reactor, a trickle-bed reactor, a moving bed reactor, a rotating bed reactor, a fluidized bed reactor, and a slurry reactor. Catalytic cracking of hydrocarbon, particularly n-dodecane and naptha, with the ZSM-5 of the present disclosure yields one or more conversion products. The conversion product may have the same carbon atoms as that of the parent hydrocarbon or may result in a product having carbon atoms less than/smaller carbon atoms than the hydrocarbon. Some of the hydrocarbon that does not react with the ZSM-5 zeolite is called an unreacted hydrocarbon. The unreacted hydrocarbon may be contacted again with the ZSM-5 zeolite for the catalytic cracking process.

In an embodiment, the conversion product obtained by contacting the dodecane or heavy naptha is olefins and/or aromatic compounds. In an embodiment, the yield of the conversion product obtained on catalytic cracking of dodecane is 90% to 95%, and the yield of the conversion product obtained on catalytic cracking of the heavy naphtha is 40-70%. The increased yield of the conversion product can be attributed to the increased diffusivity and accessibility of the hydrocarbons to the ZSM-5 (owing to the presence of mesopores and an increase in total pore volume, and external surface area), thereby enhancing the catalytic cracking process.

In an embodiment, the conversion product is 30-40 vol. % of the aromatic compounds. The ZSM-5 performs primary and secondary reactions of shape selectivity of aromatization by cyclization of alkanes and produces total aromatics selectivity of 30-40 vol. %, which mainly toluene, xylenes, ethyl benzene, trimethyl benzene, dimethyl ethyl benzene, diethyl benzene from heavy naphtha reforming.

In another embodiment, the ZSM-5 performs shape selectivity to olefins of primary reaction to produce olefins of butenes, pentenes, hexenes, heptenes, octenes, nonenes, decaenes, isoundecanes in the total selectivity range of 40-60 vol. % of dodecane conversion.

In yet another embodiment, the ZSM-5 performs shape selectivity to transalkylation of secondary reaction to produce isomer of isobutanes, isopentanes, isohexanes, isoheptanes, isooctanes, isononanes, isodecanes, isoundecanes in the total selectivity range of 20-25 vol. % of dodecane conversion and heavy naphtha conversion.

### EXAMPLES

The following examples demonstrate a method of preparing a ZSM-5 (zeolite). The examples are provided solely for illustration and are not to be construed as limitations of the present disclosure, as many variations thereof are possible without departing from the spirit and scope of the present disclosure.

### Example 1: Method of Preparing ZSM-5 (Nanosized MFI) or Zeolite

A method of preparing a ZSM-5 in sequence is performed via a plurality of under-listed steps. The steps provided below are to be read in conjunction with FIG. 1B. The method includes four stages: a hydrothermal stage (step 1), a first calcination stage (step 2), a protonation stage (step 3), and a second calcination stage (step 4).

Step 1 with reference to FIG. 1B: The zeolite is prepared by pouring, via the line [105], 37.344−0.488×(±0.05) Kg of deionized water (H₂O) in a tank of the hydrothermal unit [100], where x is the weight of aluminum sulfate octahydrate 9 (Al₂(SO₄)₃.18H₂O) in the solution. After that, x±0.01 Kg of aluminum sulfate octahydrate (Al₂(SO₄)₃.18H₂O) was added to the deionized water to synthesize silicate (Si-MFI) and MFI with different Si/Al ratios, where x is in the range of 0.0 to 0.64±0.01 Kg, to form a first mixture. The first mixture was aged vigorously through the line [140] to allow the complete dissolution of the aluminum sulfate octahydrate in the deionized water. Then, 15.96±0.05 Kg of tetrapropylammonium hydroxide (TPAOH, 1M) was added to the first mixture to facilitate the formation of MFI structure and to enhance the availability of silanol and silanol nest. The first mixture was aged for 5±1 min. After that, 10±0.02 Kg of tetraethyl orthosilicate (TEOS) was added to the first mixture and then hydrolyzed by vigorous stirring through the line [140] between 0.03 to 3 days. Once a clear solution was obtained and all the TEOS was hydrolyzed, the solution was heated [120] for 15 h±2 h at 110° C.±10° C., under static conditions, to form a second mixture.

Step 2: The second mixture synthesized in a hydrothermal unit [100] was evacuated through the line [110] and fed into an inline process centrifuge unit [150] to separate the light phase and heavy phase. The heavy phase primarily contained the second mixture needed for forming the zeolite. The centrifugation was carried out at a centrifuge speed of 2500 revolutions per minute (rpm) to 3500 rpm and a flow rate of 0.1±0.02 kilograms per minute (Kg/min). The light phase would pass through line [160], and the heavy phase was evacuated via line [210] and introduced into the first calcination unit [200]. In the first calcination unit [200], the zeolite was initially heated in a reactor [220] to 100±10° C. for drying for about 12 h to 18 h±2 h. After that, the calcination was carried out in the reactor [220] at a temperature of 525±10° C. for 2 h to 12 h±0.1 h at a heating ramp rate of 1 degree Celsius per minute (° C./min) to 3° C./min to obtain a first zeolite. Once the calcination was completed, the first calcination unit [200] was cooled down to 20° C. to 50° C.

Step 3: A solution of ammonium nitrate with molarity between 0.01 and 2 M was introduced to the protonation unit [300] through the inlet [305], and the first zeolite was also introduced into the protonation unit [300] through the inlet [330]. The ratio of the first zeolite to ammonium nitrate solution was maintained to be 1:20. The protonation unit [300] was heated via a hydrothermal oven [320] to a temperature of 85±3° C. for 1 h to 6 h using a hydrothermal oven. The mixture was aged vigorously using the line [340]. The ammonium nitrate solution was drained through the line [360] after the zeolite powder (protonated zeolite) settled down. The repetition of protonation may be carried out several times between 1 and 3 times by introducing the ammonium nitrate solution again through the line [305]. The protonated zeolite is further washed with DI H₂O twice, introduced through the line [305], at a zeolite-to-water ratio of 1:10. The water was drained after the zeolite powder settled down.

Step 4: The protonated zeolite was evacuated from the protonation unit [300] and fed into a second calcination unit [400] through the inlet [405]. Here, the protonated zeolite was heated in a reactor [420] up to a temperature of about 100±10° C. for drying for about 12 h to 18 h±2 h. Then, the dried protonated zeolite was calcined in the reactor [420] at a temperature of about 525° C.±10° C. for a period of about 2 h to 12 h±0.1 h at a heating ramp of 1° C./min to 3° C./min via the heater and then cooled down for 1 h to 10 h to obtain ZSM-5.

### Example 2: Preparation of ZSM-5 with a Si/Al Ratio of 25

The method includes dissolving 0.640±0.01 Kg of aluminum sulfate octahydrate in 37.03±0.05 kg of deionized water (H₂O) to yield a solution. The solution was stirred until there was complete dissolution of aluminum sulfate octahydrate. After that, 15.96±0.05 Kg of tetrapropylammonium hydroxide (TPAOH, 1M) was added to the solution to facilitate the formation of the MFI structure and to enhance the availability of silanol and silanol nest. The solution was aged for 5±1 min. Later, 10±0.02 Kg of tetraethyl orthosilicate (TEOS) was added to the solution, and the solution was vigorously stirred for about 90 minutes for hydrolysis of TEOS. The stirring continued till a clear solution was obtained, and all the silica was hydrolyzed. After that, the mixture was heated up for 15 h (±2 h) at 110° C. (±10° C.) under static conditions. Then, the zeolite was evacuated and dried.

### Example 3: Preparation of ZSM-5 with a Si/Al Ratio of 50

The method includes dissolving 0.320±0.01 Kg of aluminum sulfate octahydrate in 37.19±0.05 kg of deionized water (H₂O) to yield a solution. The solution was stirred until there was complete dissolution of aluminum sulfate octahydrate. After that, 15.96±0.05 Kg of TPAOH, 1M, was added to the solution to facilitate the formation of the MFI structure and to enhance the availability of silanol and silanol nest. The solution was aged for 5±1 min. Later, 10±0.02 Kg of TEOS was added to the solution, and the solution was vigorously stirred for about 90 minutes for hydrolysis of TEOS. The stirring continued till a clear solution was obtained, and all the silica was hydrolyzed. After that, the mixture was heated up for 15 h (±2 h) at 110° C. (±10° C.) under static conditions for drying. After drying, the mixture was calcined (first calcination) at controlled heating conditions up to 550±10° C. for 1.5 h (±0.05 h) to 12 h (±0.05 h) to obtain ZSM-5 with a Si/Al ratio 50.

### Example 4: Preparation of ZSM-5 with a Si/Al Ratio of 75

The method includes dissolving 0.213±0.01 Kg of aluminum sulfate octahydrate in 37.24±0.05 kg of deionized water (H₂O) to yield a solution. The solution was stirred until there was complete dissolution of aluminum sulfate octahydrate. After that, 15.96±0.05 Kg of TPAOH, 1M, was added to the solution to facilitate the formation of the MFI structure and to enhance the availability of silanol and silanol nest. The solution was aged for 5±1 min. Later, 10±0.02 Kg of TEOS was added to the solution, and the solution was vigorously stirred for about 90 minutes for hydrolysis of TEOS. The stirring continued till a clear solution was obtained, and all the silica was hydrolyzed. After that, the mixture was heated up for 15 h (±2 h) at 110° C. (±10° C.) under static conditions for drying. After drying, the mixture was calcined (first calcination) at controlled heating conditions up to 550±10° C. for 1.5 h (±0.05 h) to 12 h (±0.05 h) to obtain ZSM-5 with a Si/Al ratio of 75.

### Example 5: Preparation of ZSM-5 with a Si/Al Ratio of 100

The method includes dissolving 0.16±0.01 Kg of aluminum sulfate octahydrate in 37.27±0.05 kg of deionized water (H₂O) to yield a solution. The solution was stirred until there was complete dissolution of aluminum sulfate octahydrate. After that, 15.96±0.05 Kg of TPAOH, 1M, was added to the solution to facilitate the formation of the MFI structure and to enhance the availability of silanol and silanol nest. The solution was aged for 5±1 min. Later, 10±0.02 Kg of TEOS was added to the solution, and the solution was vigorously stirred for about 90 minutes for hydrolysis of TEOS. The stirring continued till a clear solution was obtained, and all the silica was hydrolyzed. After that, the mixture was heated up for 15 h (±2 h) at 110° C. (±10° C.) under static conditions for drying. After drying, the mixture was calcined (first calcination) at controlled heating conditions up to 550±10° C. for 1.5 h (±0.05 h) to 12 h (±0.05 h) to obtain ZSM-5 with a Si/Al ratio of 100.

### Example 6: Surface Modification of ZSM-5 with a Si/Al Ratio of 50

The ZSM-5 obtained in Example 3 (after the first calcination) was subjected to protonation using an aluminum salt (preferably ammonium nitrate), followed by a second calcination to obtain ZSM-5. A total of 6 ZSM-5 zeolites, derived from zeolites with a Si/Al ratio of 50/50, were prepared by adopting three strategies—i) controlling the calcination time to obtain a zeolite best suited for catalytic cracking of different hydrocarbons, (ii) applying controlled protonation followed by calcination when alkali or alkali earth metal source is absent, (iii) studying the effect of Si/Al ratio on the catalytic activity and catalytic stability.

1) The zeolite (obtained after a first calcination time of 1.5 h) was protonated in the protonation stage with ammonium nitrate solution (2 M solution), with zeolite to ammonium nitrate solution of 1:20. The mixture was aged vigorously and heated at 85±3° C. for 3-4 hours in an oven. After protonation, the oven was shut down, and the liquid was separated and drained. The repetition of protonation was carried out once again under the same conditions. Deionized water was used finally to wash the protonated zeolite twice by zeolite to water ratio of 1:10. The protonated zeolite was dried and then calcined again in the second calcination unit at 550° C. for 1.5 h to obtain the ZSM-5, designated as “calcined for 1.5 h—protonated with 2 M ammonium nitrate solution—calcined for 1.5 h”.

2) The first zeolite (obtained after a first calcination time of 5 h) was protonated in the protonation stage with ammonium nitrate solution (2 M solution), with zeolite to ammonium nitrate solution of 1:20. The mixture was aged vigorously and heated at 85±3° C. for 3-4 hours in an oven. After protonation, the oven was shut down, and the liquid was separated and drained. The repetition of protonation was carried out once again under the same conditions. Deionized water was used finally to wash the protonated zeolite twice by zeolite to water ratio of 1:10. The protonated zeolite was dried and then calcined again in the second calcination unit at 550° C. for 5 h to obtain the ZSM-5, designated as “calcined for 5 h—protonated with 2 M ammonium nitrate solution—calcined for 5 h”.

3) The first zeolite (obtained after a first calcination time of 12 h) was protonated in the protonation stage with ammonium nitrate solution (2 M solution), with zeolite to ammonium nitrate solution of 1:20. The mixture was aged vigorously and heated at 85±3° C. for 3-4 hours in an oven. After protonation, the oven was shut down, and the liquid was separated and drained. The repetition of protonation was carried out once again under the same conditions. Deionized water was used finally to wash the protonated zeolite twice by zeolite to water ratio of 1:10. The protonated zeolite was dried and then calcined again in the second calcination unit at 550° C. for 1.5 h to obtain the ZSM-5, designated as “calcined for 12 h—protonated with 2 M ammonium nitrate solution—calcined for 1.5 h”.

4) The first zeolite (obtained after a first calcination time of 12 h) was protonated in the protonation stage with ammonium nitrate solution (2 M solution), with zeolite to ammonium nitrate solution of 1:20. The mixture was aged vigorously and heated at 85±3° C. for 3-4 hours in an oven. After protonation, the oven was shut down, and the liquid was separated and drained. The repetition of protonation was carried out once again under the same conditions. Deionized water was used finally to wash the protonated zeolite twice by zeolite to water ratio of 1:10. The protonated zeolite was dried and then calcined again in the second calcination unit at 550° C. for 12 h to obtain the ZSM-5, designated as “calcined for 12 h—protonated with 2 M ammonium nitrate solution—calcined for 12 h”.

5) The first zeolite (obtained after a first calcination time of 5 h) was protonated in the protonation stage with ammonium nitrate solution (1 M solution), with zeolite to ammonium nitrate solution of 1:20. The mixture was aged vigorously and heated at 85±3° C. for 3-4 hours in an oven. After protonation, the oven was shut down, and the liquid was separated and drained. The repetition of protonation was carried out once again under the same conditions. Deionized water was used finally to wash the protonated zeolite twice by zeolite to water ratio of 1:10. The protonated zeolite was dried and then calcined again in the second calcination unit at 550° C. for 5 h to obtain the ZSM-5, designated as “calcined for 5 h—protonated with 1 M ammonium nitrate solution—calcined for 5 h”.

6) The first zeolite (obtained after a first calcination time of 5 h) was protonated in the protonation stage with ammonium nitrate solution (0.1 M solution), with zeolite to ammonium nitrate solution of 1:20. The mixture was aged vigorously and heated at 85±3° C. for 3-4 hours in an oven. After protonation, the oven was shut down, and the liquid was separated and drained. The repetition of protonation was carried out once again under the same conditions. Deionized water was used finally to wash the protonated zeolite twice by zeolite to water ratio of 1:10. The protonated zeolite was dried and then calcined again in the second calcination unit at 550° C. for 5 h to obtain the ZSM-5, designated as “calcined for 5 h—protonated with 0.1 M ammonium nitrate solution—calcined for 5 h”.

The ZSM-5 prepared by method in of the present disclosure were confirmed via X-ray diffraction (XRD) analysis, scanning electron microscopy (SEM), Brunauer-Emmett-Teller (BET), temperature programmed desorption (TPD) analysis, Fourier transform infrared (FTIR) spectroscopy, and pyridine-FTIR spectroscopy, to estimate the role of these controlled strategies on crystallinity, phase purity, unit cell parameters, morphology, textural properties, acidity, chemical structure, acidity distribution and catalytic performance.

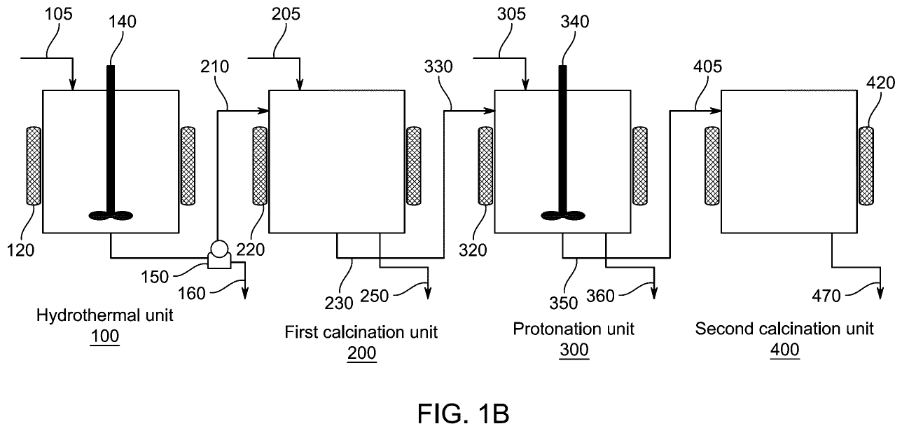

Results and Discussion Referring to FIG. 2, the XRD analysis of zeolite samples with Si/Al ratios of 50, 75, and 100 (prepared by process steps described in example 3 to example 5) is depicted. The XRD data confirms that the prepared zeolites are crystalline and suggest the successful formation of the zeolites.

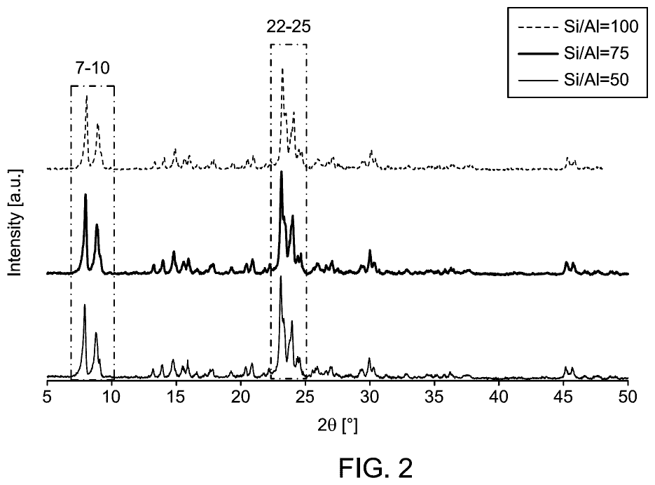

Referring to FIG. 3, XRD analysis of the zeolite samples synthesized with a Si/Al ratio of 50, before and after first calcination is depicted. The characteristic peaks at 2θ of 7.94 and 8.82 for the as-synthesized samples are shown to be lower in intensity than those calcined. The peaks were prominent when the sample was calcined under a controlled environment for 1.5 h to 5 h. However, when the calcination was carried out in an uncontrolled environment, the peak intensity was reduced, as shown after a 12-hour period of calcination. The synthesis of zeolites in a controlled environment for a specific calcination period removes the templating agent or organic structure directing agents (OSDA) and maintains the framework of ZSM-5.

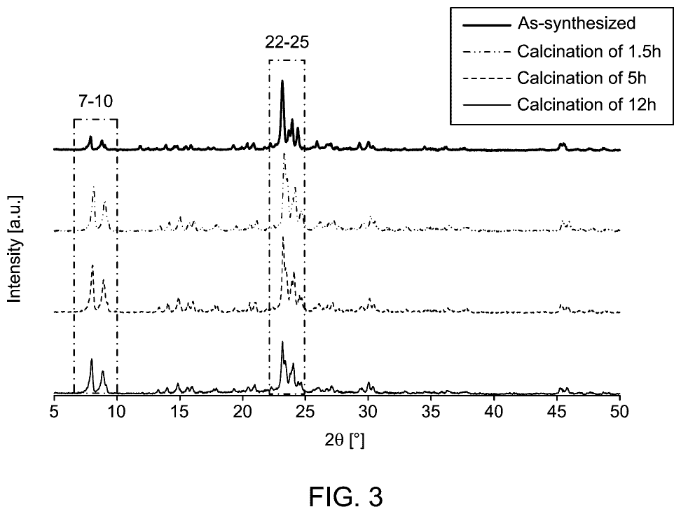

Referring to FIG. 4, XRD analysis of the ZSM-5 synthesized with a Si/Al ratio of 50 with different calcination times before and after protonation is depicted. The ZSM-5 prepared in sequence includes a first calcination stage, a protonation stage, and a second calcination stage after protonation. The intensity of the characteristic peaks was found to be related, as observed between the peaks at the 20 of 7 to 9 and 22 to 25, for all samples shown in FIG. 2-FIG. 4. In the first calcination stage under controlled conditions, when OSDA is in the zeolite pore, the peak intensity in the ranges of 7 to 10 and 22 to 25 may increase to the maximum once the OSDA is burned. The ratio of the intensities at [22 to 25] and [7 to 10], which was maximum before the calcination, may reduce as the calcination time increases due to the relative increase in the intensities of the peaks of the first range and decreases of the peak's intensities of the second range. Further, the total intensities of all peaks of each sample are reduced as the calcination time increases, as shown in FIG. 2 to FIG. 4. However, as can be seen from FIG. 2, the zeolite samples with Si/Al ratios of 50, 75, and 100 have similar intensity and ratios at the same calcination conditions and different Si/Al ratios.

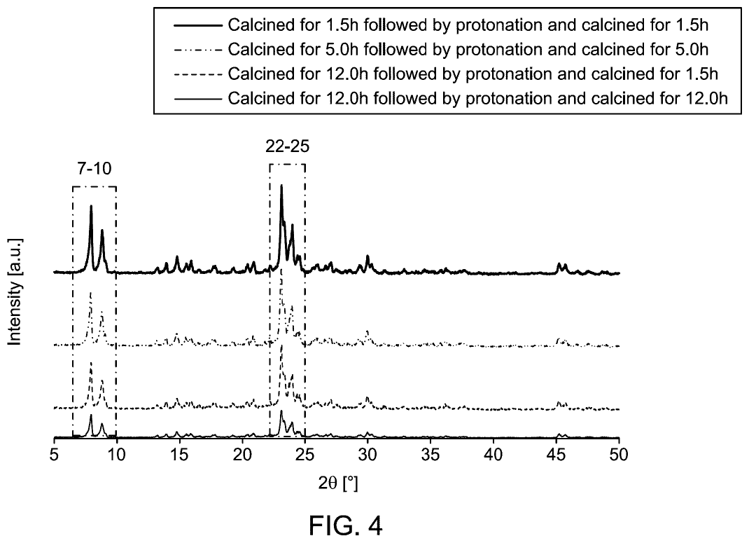

Field emission scanning electron microscopy (FESEM) was utilized to determine the particle size and morphology of the ZSM-5 prepared in sequence. As shown in FIG. 5, the particle size of ZSM-5 ranged from 200 nanometers (nm) to 300 nm for a zeolite sample with a Si/Al ratio of 25-75, and about 250-350 nm for a zeolite sample with a Si/Al ratio of 100.

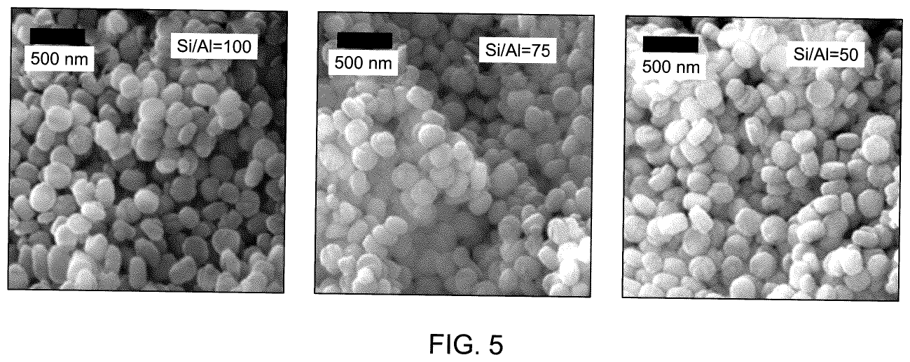

The ZSM-5 shows mesoporous characteristics. Textural properties of ZSM-5 were evaluated by nitrogen (N₂) sorption to determine BET surface area, external surface area, and pore volume. The adsorption isotherm of the ZSM-5 was found to have a combination of type I and type IV isotherms. A hysteresis loop was also present, which may signify the association of pore condensation into mesopores. The BET isotherm has high uptake with monolayer coverage of 91 cubic centimeters per gram (cm³/g) STP, which indicates the adsorption ability of the zeolite due to the availability of micropores and mesopores (FIG. 6). Further, the ZSM-5 prepared in sequence showed a BET surface area, an external surface area, and a microporous area of approximately 418 square meters per gram (m²/g), 216 m²/g, and 209 m²/g, respectively.

Further, varying the aluminum concentration in the protonation solution may lead to a limited tuning of the textural properties, indicating that the zeolites exhibit identical textural properties. The external surface area of ZSM-5 prepared in sequence showed a huge value compared to several conventional zeolites, making it a better choice for catalytic cracking and heavy oil upgrading, such as dodecane. Another finding from the present disclosure indicated that the external surface area, total surface area, and microporous area are highly affected by the calcination time before and after the protonation stage, the concentration of protonation solution, and the number of protonation cycles are listed in Table 1. The lower the calcination time, the higher the BET surface area and maximum external surface area. The effect of calcination time may vary from one zeolite to another based on the nature and the ability of the organic structure directing agent and its combustion.

The total pore volume of ZSM-5 prepared in sequence was evaluated using Horvath-Kawazoe correlations and was found to be in the range of 0.410 cm³/g to 0.475 cm³/g. These samples showed a large range of meso-porosity, which makes it suitable for several catalytic cracking of heavy oil upgrading, such as, but not limited to, dodecane. Similarly, it confirmed that total pore volume, microporous pore volume, and mesoporous pore volume are highly affected by the calcination time before and after the protonation stage. As shown in Table 1, as the calcination-controlled time increases, the total pore volume increases. The uncontrolled condition (12 hours) resulted in a ZSM-5 structure with a very large pore volume due to the loss of extra silanol groups and silanol nest. Further, the calcination under uncontrolled conditions resulted in burning some elemental material in the catalyst structure, further resulting in a larger pore volume. Maintaining a balance between the total pore volume and the amount of vital acidic sites in the zeolite is necessary.

TABLE 1
Textural properties of ZSM-5 synthesized in sequence with Si/Al ratios of 50, 75, and 100.

| Si/Al | | Particle | | | | | | |
|---|---|---|---|---|---|---|---|---|
| ratio | Condition | size (nm) | S_{BET} | S_{micro}^{a} | Sₑₓₜ^{b} | Vₜₒₜₐₗ^{c} | V_{micro}^{d} | Vₘₑₛₒ^{e} |
| 100 | Calcined for 5 h, protonated, | 257 | 405.2 | 199 | 199 | 0.459 | 0.101 | 0.358 |
| | and then calcined for 5 h | | | | | | | |
| 75 | Calcined for 5 h, protonated, | 260 | 405.4 | 205 | 198 | 0.439 | 0.102 | 0.337 |
| | and then calcined for 5 h | | | | | | | |
| 50 | Calcined for 1.5 h, protonated, | 283 | 418.0 | 202 | 216 | 0.428 | 0.097 | 0.331 |
| | and then calcined for 1.5 h | | | | | | | |
| 50 | Calcined for 5 h, protonated, | 283 | 406.1 | 209 | 197 | 0.427 | 0.103 | 0.324 |
| | and then calcined for 5 h | | | | | | | |
| 50 | Calcined for 12 h, protonated, | 283 | 351.3 | 185 | 166 | 0.475 | 0.088 | 0.387 |
| | and then calcined for 12 h | | | | | | | |

where,
^{a}t-plot signifies micropore surface area,
^{b}t-plot signifies external surface area,
^{c}(P/Pₒ = 0.98886), Horvath-Kawazoe,
^{c-1}(P/Pₒ = 0.9693),
^{d}t-plot signifies micropore volume,
^{e}Vₘₑₛₒ = Vₜₒₜₐₗ − V_{micro}

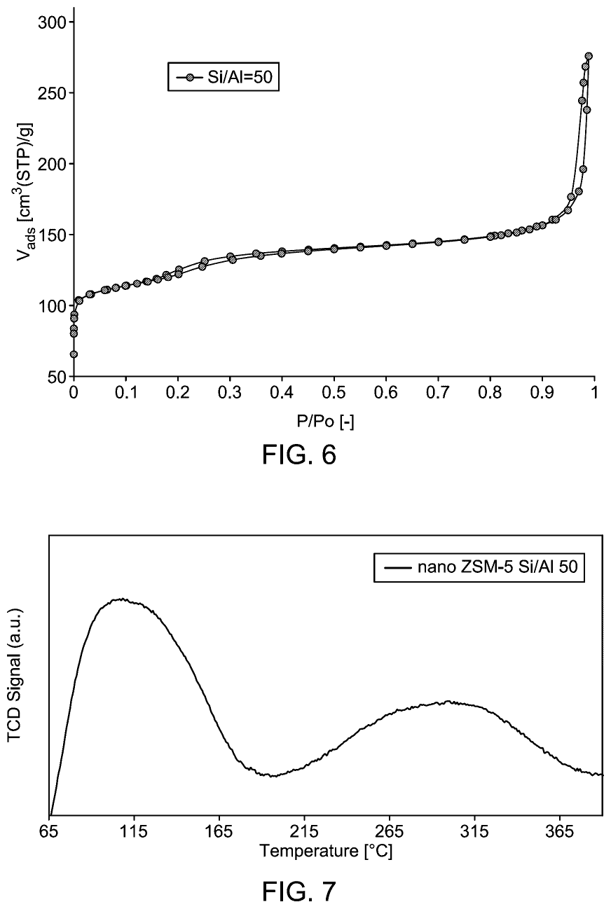

The catalytic performance over zeolitic materials, such as textural properties and surface acidity, was controlled. The present disclosure may provide controlled acidity, which is required to enhance the catalytic performance and stability of the zeolite. The influence of aluminum concentration on the acidity strength and acidity distribution of the ZSM-5 zeolite is studied using temperature-programmed desorption of ammonia (NH₃-TPD). In general, two distinct peaks may be obtained in the zeolitic materials in two temperature regions: low-temperature (weak acid) and high-temperature (strong acid) regions. As shown in FIG. 7, diammoniate aluminosilicate nanosized MFI zeolite has two distinct peaks at around 225° C. and 440° C., which refer to weak and strong acids, respectively.

Generally, acids are classified by Lewis acid site and Brønsted acid site. However, further study on pyridine adsorption using FTIR was employed to specify the nature of each weak and strong acid site obtained from NH3-TPD. Quantitative analysis of acid distribution is obtained by FTIR detection of pyridine vibration in the range of 1400 cm⁻¹ to 1800 cm⁻¹. In this range, Brønsted and Lewis acid sites are detected at the bands of 1455 cm⁻¹ and 1545 cm⁻¹, which corresponds to the linkage of pyridine to Lewis acid sites (coordinatively bonded) and the adsorption of pyridinium ion on Brønsted acid sites (protonated pyridine), respectively. However, a third peak is observed at the band of 1490 cm⁻¹, assigned to a combined contribution from pyridinium ion coordinated to the Lewis acid site and adsorbed on the Brønsted acid site.

The ZSM-5 zeolites are prepared in sequence without an alkaline source. The acidity of ZSM-5 before and after the protonation stage is investigated. According to the present disclosure, the acidity of the zeolite samples at different calcination-controlled periods before the protonation stage with ammonium nitrate solution and the acidity of ZSM-5 zeolite samples after the protonation using 2 M of ammonium nitrate and calcination for different calcination-controlled periods is studied using adsorption of pyridine and FTIR. The results of this study are presented in Table 2. As shown in Table 2, in the first strategy where the sample was only calcined (zeolite before protonation), peaks around 1440 cm⁻¹ were shown due to physisorbed pyridine, which can be removed by evacuation above 200° C. This peak was found to be related to the calcination time. As the calcination-controlled period increases, the intensity and the amount of physiosorbed acid decrease. The higher the physiosorbed acid, the lower the calcination-controlled period is needed. Furthermore, due to the absence of protonated sites, the Brønsted acid site did not appear during characterization before the protonation step. On the other hand, when ZSM-5 prepared in sequence was protonated, followed by calcination, both Lewis and Brønsted acid sites appeared. Moreover, it was confirmed that the level of acidity of both Lewis and Brønsted acid sites is highly affected by the calcination-controlled period before and after the protonation stage. The calcination stage before and after protonation and concentration of protonation solution, as well as the number of protonation cycling stages, is shown in Table 2. A controlled level of concentrations in the protonation solution in the protonation stage may lead to the controlled concentrations of both Lewis and Brønsted acid sites in the ZSM-5 prepared in sequence, which is required to start the reaction and maximize catalyst selectivity.

TABLE 2
Lewis, Brønsted, and total acidity of ZSM-5 synthesized in sequence with different
calcination and protonation time determined by the adsorption of pyridine and FTIR.

| | | | | Lewis/ |
|---|---|---|---|---|
| | C_{Lewis} | C_{Brønsted} | | Brønste |
| Treatment mode | (μmole/g) | (μmole/g) | Total acidity | (L/B) |
| Calcined for 1.5 h | 76 | 0 | 76 | — |
| Calcined for 5 h | 52 | 0 | 52 | — |
| Calcined for 12 h | 24 | 0 | 24 | — |
| Calcined for 1.5 h- Protonated with 2M | 33 | 22 | 55 | 1.48 |
| ammonium nitrate solution- Calcined for 1.5 h | | | | |
| Calcined for 5 h- Protonated with 2M ammonium | 37 | 52 | 90 | 0.72 |
| nitrate solution- Calcined for 5 h | | | | |
| Calcined for 12 h- Protonated with 2M ammonium | 37 | 35 | 72 | 1.05 |
| nitrate solution- Calcined for 1.5 h | | | | |
| Calcined for 12 h- Protonated with 2M ammonium | 47 | 33 | 80 | 1.42 |
| nitrate solution- Calcined for 12 h | | | | |
| Calcined for 5 h- Protonated with 2M ammonium | 37 | 52 | 90 | 0.72 |
| nitrate solution- Calcined for 5 h | | | | |
| Calcined for 5 h- Protonated with 1M ammonium | 31 | 36 | 67 | 0.86 |
| nitrate solution- Calcined for 5 h | | | | |
| Calcined for 5 h- Protonated with 0.1M | 21 | 24.6 | 46 | 0.86 |
| ammonium nitrate solution- Calcined for 5 h | | | | |

Aspects of the present disclosure provide a method for making ZSM-5. Further, the method as described in the present disclosure aims to control, adjust, and restore the acidity of ZSM-5. The ZSM-5 synthesized using the present method has a total pore volume of 0.459±0.05 cm³/g, which is 4.5 times greater than the microporous volume of 0.101±0.05 cm³/g. The mesoporous pore volume of 3.58±0.05 cm³/g was 3.5 times greater than the microporous volume. The ZSM-5 of the present disclosure also has a high external surface area and can effectively be used as a catalyst for catalytic cracking of hydrocarbons.

A preparation process of nanosized MFI zeolite in sequence may consist of four stages to produce nanosized MFI with controlled nine scale level of acidities of Lewis and Brønsted acid scales for one nanosized zeolite material.

Nanosized MFI of Si/Al 25 gel can be made by preparing a zeolite formulation solution by dissolving 0.640±0.01 kg of aluminum sulfate octahydrate in 37.03±0.05 kg of deionized water (H₂O and stirring until dissolving the aluminum source. After that, 15.96±0.05 kg of tetrapropylammonium hydroxide (TPAOH, 1M) was added to the synthesis mixture to facilitate the formation of MFI structure and to enhance the availability of silanol and silanol nest. The solution was aged for 5±1 min vigorously. After that 10±0.02 kg of tetraethyl orthosilicate was added to the mixture and then allowed to be hydrolyzed by vigorous stirring between 90 min. Once the solution became a clear solution and all silica was hydrolyzed, mixture was heated up 15 h (±2 h) at 110° C. (±10° C.) under static condition. Then the zeolite formulation which was synthesized evacuated and dried.

Nanosized MFI of Si/Al 50 gel can be prepared as follows: a zeolite formulation solution gel is prepared by dissolving 0.320±0.01 kg of aluminum sulfate octahydrate in 37.19±0.05 kg of deionized water (H₂O). The solution was stirred until the dissolving of aluminum source. After that, 15.96±0.05 kg of tetrapropylammonium hydroxide (TPAOH, 1M) was added to the synthesis mixture to facilitate the formation of MFI structure and to enhance the availability of silanol and silanol nest. Solution was aged for 5±1 min vigorously. After that 10±0.02 kg of tetraethyl orthosilicate was added to the mixture and then allowed to be hydrolyzed by vigorous stirring between 90 min. Once the solution became a clear solution and all silica was hydrolyzed, mixture was heated up 15h (±2h) at 110° C. (±10° C.) under static condition. Then the zeolite formulation which was synthesized evacuated and dried.

Nanosized MFI of Si/Al 75 gel can be made by forming a zeolite formulation solution gel by dissolving 0.213±0.01 kg of aluminum sulfate octahydrate in 37.24±0.05 kg of deionized water (H₂O). The solution was stirred until the dissolving of aluminum source. After that, 15.96±0.05 kg of tetrapropylammonium hydroxide (TPAOH, 1M) was added to the synthesis mixture to facilitate the formation of MFI structure and to enhance the availability of silanol and silanol nest. Solution was aged for 5±1 min vigorously. After that 10±0.02 kg of tetraethyl orthosilicate was added to the mixture and then allowed to be hydrolyzed by vigorous stirring between 90 min. Once the solution became a clear solution and all silica was hydrolyzed, mixture was heated up 15h (±2h) at 110° C. (±10° C.) under static condition. Then the zeolite formulation which was synthesized evacuated and dried.

Nanosized MFI of Si/Al 100 gel can be prepared as follow: a zeolite formulation solution gel was prepared by dissolving 0.160±0.01 kg of aluminum sulfate octahydrate in 37.27±0.05 kg of deionized water (H₂O). The solution was stirred until the dissolving of aluminum source. After that, 15.96±0.05 kg of tetrapropylammonium hydroxide (TPAOH, 1M) was added to the synthesis mixture to facilitate the formation of MFI structure and to enhance the availability of silanol and silanol nest. Solution was aged for 5±1 min vigorously. After that 10±0.02 kg of tetraethyl orthosilicate was added to the mixture and then allowed to be hydrolyzed by vigorous stirring between 90 min. Once the solution became a clear solution and all silica was hydrolyzed, mixture was heated up 15h (±2h) at 110° C. (±10° C.) under static condition. Then the zeolite formulation which was synthesized evacuated and dried.

Nano MFI Condition 1: The nano structure MFI zeolite was sent to calcination stage 1 at controlled condition of heating up to 550±10° C. for 1.5 h (±0.05h). The controlled condition would produce Lewis acid scale in the range of 76±15 mole/g.

Nano MFI Condition 2: The nano structure MFI zeolite was sent to calcination stage 1 at controlled condition of heating up to 550±10° C. for 5 h (±0.05h). The controlled condition would produce Lewis acid sites scale in the range of 52±15 mole/g.

Nano MFI Condition 3: The nano structure MFI zeolite was sent to calcination stage 1 at controlled condition of heating up to 550±10° C. for 12 h (±0.05h). The controlled condition would produce Lewis acid scale in the range of 24±15 mole/g.

Nano MFI Condition 4: when nanosized MFI evacuated for further controlled treatment in sequence by using protonation stage followed by calcination stage 2. The nanosized MFI evacuated 5 was protonated in protonation stage with ammonium nitrate solution with 2 M solution with zeolite to protonation solution of ammonium nitrate solution of 1:20. Mixture was aged vigorously and heated at 85±3° C. for 3-4 hour. After protonation, the oven shut down and liquid was separated and drained. The repetition of protonation was carried once again at same condition. Deionized water was used finally to wash the protonated zeolite twice by zeolite to water ratio of 1:10. Zeolite was dried and then calcined again in calcination stage 2 at 550° C. for 1.5 h. The nanosized MFI acidity upgraded to be both Lewis and Brønsted acid scales in the range of 33±5 and 22±5 mole/g, respectively.

Nano MFI Condition 5: when nanosized MFI evacuated for further controlled treatment in sequence by using protonation stage followed by calcination stage 2. The nanosized MFI evacuated 5 was protonated in protonation stage with ammonium nitrate solution with 2 M solution with zeolite to protonation solution of ammonium nitrate solution of 1:20. Mixture was aged vigorously and heated at 85±3° C. for 3-4 hour. After protonation, the oven shut down and liquid was separated and drained. The repetition of protonation was carried once again at same condition. Deionized water was used finally to wash the protonated zeolite twice by zeolite to water ratio of 1:10. Zeolite was dried and then calcined again in calcination stage 2 at 550° C. for 5 h. The nanosized MFI acidity upgraded to be both Lewis and Brønsted acid scales in the range of 37±5 and 52±5 mole/g, respectively.

Nano MFI Condition 6: when nanosized MFI evacuated for further controlled treatment in sequence by using protonation stage followed by calcination stage 2. The nanosized MFI evacuated 5 was protonated in protonation stage with ammonium nitrate solution with 2 M solution with zeolite to protonation solution of ammonium nitrate solution of 1:20. Mixture was aged vigorously and heated at 85±3° C. for 3-4 hour. After protonation, the oven shut down and liquid was separated and drained. The repetition of protonation was carried once again at same condition. Deionized water was used finally to wash the protonated zeolite twice by zeolite to water ratio of 1:10. Zeolite was dried and then calcined again in calcination stage 2 at 550° C. for 1.5 h. The nanosized MFI acidity upgraded to be both Lewis and Brønsted acid scales in the range of 37±5 and 35±5 mole/g, respectively.

Nano MFI Condition 7: when nanosized MFI evacuated for further controlled treatment in sequence by using protonation stage followed by calcination stage 2. The nanosized MFI evacuated 5 was protonated in protonation stage with ammonium nitrate solution with 2 M solution with zeolite to protonation solution of ammonium nitrate solution of 1:20. Mixture was aged vigorously and heated at 85±3° C. for 3-4 hour. After protonation, the oven shut down and liquid was separated and drained. The repetition of protonation was carried once again at same condition. Deionized water was used finally to wash the protonated zeolite twice by zeolite to water ratio of 1:10. Zeolite was dried and then calcined again in calcination stage 2 at 550° C. for 12 h. The nanosized MFI acidity upgraded to be both Lewis and Brønsted acid scales in the range of 47±5 and 33±5 mole/g, respectively.

Nano MFI Condition 8: when nanosized MFI evacuated for further controlled treatment in sequence by using protonation stage followed by calcination stage 2. The nanosized MFI evacuated 5 was protonated in protonation stage with ammonium nitrate solution with 1 M solution with zeolite to protonation solution of ammonium nitrate solution of 1:20. Mixture was aged vigorously and heated at 85±3° C. for 3-4 hour. After protonation, the oven shut down and liquid was separated and drained. The repetition of protonation was carried once again at same condition. Deionized water was used finally to wash the protonated zeolite twice by zeolite to water ratio of 1:10. Zeolite was dried and then calcined again in calcination stage 2 at 550° C. for 5 h. The nanosized MFI acidity upgraded to be both Lewis and Brønsted acid scales in the range of 31±5 and 21±5 mole/g, respectively.

Nano MFI Condition 9: when nanosized MFI evacuated for further controlled treatment in sequence by using protonation stage followed by calcination stage 2. The nanosized MFI evacuated 5 was protonated in protonation stage with ammonium nitrate solution with 0.1 M solution with zeolite to protonation solution of ammonium nitrate solution of 1:20. Mixture was aged vigorously and heated at 85±3° C. for 3-4 hour. After protonation, the oven shut down and liquid was separated and drained. The repetition of protonation was carried once again at same condition. Deionized water was used finally to wash the protonated zeolite twice by zeolite to water ratio of 1:10. Zeolite was dried and then calcined again in calcination stage 2 at 550° C. for 5 h. The nanosized MFI acidity upgraded to be both Lewis and Brønsted acid sites in the range of 21±5 and 24.5±5 μmole/g, respectively.

The nanosized of MFI prepared with the method of the present disclosure provides a zeolite nanostructure 200-300 nm for Si/Al 25-75. MFI prepared with the method of the present disclosure provides nano structure 250-350 nm for Si/Al 100.

The method preparing nanosized MFI made in sequence showed the catalytically cracking stable of heavy naphtha of dodecane from 90% to 95% and conversion of heavy naphtha of 40-70%.

The nanosized MFI with the method of the present disclosure provides primary and secondary reactions of shape selectivity of aromatization by cyclization of alkanes and produces total aromatics selectivity of 30-40 vol % mainly toluene, xylenes, ethyl benzene, trimethyl benzene, dimethyl ethyl benzene, diethyl benzene from heavy naphtha reforming.

The nanosized MFI prepared with the method of the present disclosure provides shape selectivity to olefins of primary reaction to produce olefins of butenes, pentenes, hexenes, heptenes, octenes, nonenes, decaenes, isoundecanes preferably with a total selectivity range of 40-60 vol % of dodecane conversion.

The nanosized MFI prepared in sequence method is capable of provising shape selectivity in transalkylation of secondary reaction to produce isomer of isobutanes, isopentanes, isohexanes, isoheptanes, isooctanes, isononanes, isodecanes, isoundecanes with a preferred selectivity range of 20-25 vol % of dodecane conversion and heavy naphtha conversion.

The method of the present disclosure preferably provides a zeolite having high pore volume with mesoporous volume (3.58±0.05 cm3/g) greater than three and half times of micropore volume.

Numerous modifications and variations of the present disclosure are possible in light of the above teachings. It is therefore to be understood that within the scope of the appended claims, the invention may be practiced otherwise than as specifically described herein.

1: A method of making ZSM-5, comprising:
mixing an aluminum salt and a templating agent in water to form a first mixture;
mixing a silicate with the first mixture and heating from 100-150° C. to form a second mixture;
separating a first precipitate from the second mixture;
calcining the first precipitate at a temperature of 400-600° C. for 1-12 hours to form a first zeolite;
mixing an ammonium salt and the first zeolite to form a protonated zeolite; and
calcining the protonated zeolite at a temperature of 400-600° C. for 1-12 hours to form the ZSM-5,
wherein the ZSM-5 has a Si to Al ratio of 10-100 to 1, and
wherein a mesoporous pore volume of the ZSM-5 is at least 2 times greater than a microporous pore volume of the ZSM-5.

2: The method of claim 1, wherein the ZSM-5 is crystalline.

3: The method of claim 1, wherein particles of the ZSM-5 are spherical.

4: The method of claim 1, wherein particles of the ZSM-5 have an average size of 200-400 nm.

5: The method of claim 1, wherein the ZSM-5 has a BET surface area of 350-450 m²/g.

6: The method of claim 1, wherein the ZSM-5 has a micropore surface area of 180-220 m²/g.

7: The method of claim 1, wherein the ZSM-5 has an external surface area of 150-220 m²/g.

8: The method of claim 1, wherein the ZSM-5 has a total pore volume of 0.40-0.50 cm³/g.

9: The method of claim 1, wherein the ZSM-5 has a mesoporous pore volume of 0.32-0.39 cm³/g.

10: The method of claim 1, wherein the ZSM-5 has a microporous pore volume of 0.08-0.11 cm³/g.

11: The method of claim 1, wherein the mesoporous pore volume at least 3 times greater than the microporous pore volume of the ZSM-5.

12: The method of claim 1, wherein the ZSM-5 has a Lewis acid scale in the range of 20-50 mol/g.

13: The method of claim 1, wherein the ZSM-5 has a Bronsted acid scale in the range of 20-55 μmol/g.

14: The method of claim 1, wherein the ZSM-5 does not comprise the templating agent, an alkali metal, or an alkaline earth metal.

15: A ZSM-5 made by the method of claim 1.

16: A method of cracking dodecane or heavy naphtha, comprising:
contacting the dodecane with the ZSM-5 of claim 15 to form a conversion product,
wherein the conversion product is at least one selected from the group consisting of olefins, and aromatic compounds.

17: The method of claim 16, wherein the conversion product is 30-40 vol % of the aromatic compounds.

18: The method of claim 16, wherein a yield of catalytic cracking of the dodecane is from 90% to 95% and a yield of catalytic cracking of the heavy naphtha is from 40-70%.
